(19) United States
(12) Patent Application Publication
(10) Pub. No.: US 2019/0241197 A1
(43) Pub. Date: Aug. 8, 2019

(54) DRIVE MODE SWITCH CONTROLLER, SYSTEM, AND METHOD

(71) Applicant: OMRON Corporation, Kyoto-shi (JP)

(72) Inventors: Tomoyoshi AIZAWA, Kyoto-shi (JP); Hiroshi SUGAHARA, Kyoto-shi (JP); Kazuyoshi OKAJI, Omihachiman-shi (JP); Michie UNO, Tokyo (JP); Koji TAKIZAWA, Kyoto-shi (JP)

(73) Assignee: OMRON Corporation, Kyoto-shi (JP)

(21) Appl. No.: 16/385,122

(22) Filed: Apr. 16, 2019

Related U.S. Application Data
(63) Continuation of application No. PCT/JP2017/033129, filed on Sep. 13, 2017.

(30) Foreign Application Priority Data
Mar. 10, 2017 (JP) 2017-046194

(51) Int. Cl. B60W 50/14; B60W 30/182; B60W 40/08; B60K 28/02

(52) U.S. Cl. CPC B60W 50/14; B60W 30/182; B60W 2050/0095; B60K 28/02; B60W 2040/0872; B60W 40/08

(57) ABSTRACT

An obtaining unit obtains sensing data indicating a state of a driver from a monitoring sensor for monitoring the state of the driver. A determination unit determines a degree of concentration of the driver on driving based on the sensing data. A notification controller controls, when the determination unit determines that the degree of concentration satisfies a first criterion, a notification unit to notify, before the drive mode is switched, the driver that the drive mode will be switched to the automatic drive mode, and controls, when the determination unit determines that the degree of concentration does not satisfy the first criterion, the notification unit not to notify, before the drive mode is switched, the driver that the drive mode will be switched.

### CROSS REFERENCE TO RELATED APPLICATIONS

This application is a continuation application of International Application No. PCT/JP2017/033129, filed on Sep. 13, 2017, which claims priority based on the Article 8 of Patent Cooperation Treaty from prior Japanese Patent Application No. 2017-046194, filed on Mar. 10, 2017, the entire contents of which are incorporated herein by reference.

### FIELD

The disclosure relates to a drive mode switch controller, a drive mode switch control system, and a drive mode switch control method for switching the drive mode of a vehicle from a manual drive mode to an automatic drive mode.

### BACKGROUND

In addition to a manual drive mode for driving a vehicle with a driving operation performed by a driver, an automatic drive mode has been developed for driving a vehicle along a predetermined route without a driver performing a driving operation. The automatic drive mode enables automatic driving of a vehicle by controlling, for example, a power unit, a steering unit, and a brake based on information generated by a navigation system using a global positioning system (GPS), traffic information obtained through road-to-vehicle communication, and information from a surrounding monitoring system that monitors the positions and movements of nearby pedestrians and vehicles (refer to, for example, Patent Literature 1).

The automatic drive mode is expected to reduce the burden of the driving operation performed by the driver or to ease traffic congestion.

Switching from the manual drive mode to the automatic drive mode is performed a driver by pressing a drive mode switch while driving in the manual drive mode. Besides this, switching may be automatically performed through road-to-vehicle communication or while the vehicle is traveling along a highway. The automatic drive mode has the following four levels.

In level-1 automatic driving, a vehicle automatically performs only one of acceleration, steering, and breaking. In level-2 automatic driving, a vehicle automatically performs two or more of acceleration, steering, and breaking at once. In level-3 automatic driving, a vehicle automatically performs all of acceleration, steering, and breaking, excluding taking emergency measures. In level-4 automatic driving, a vehicle automatically performs all of acceleration, steering, and breaking, including taking emergency measures.

Before switching from the manual drive mode to the automatic drive mode of any level, the driver may be notified by a voice announcement such as “The drive mode will be switched to automatic driving in xx seconds.” as well as a screen message such as “In xx seconds.” appearing on a display screen of a car navigation system or a speed meter in a scale that does not interrupt the driver's manual driving.

The driver is thus notified that the drive mode will be shortly switched to the automatic drive mode.

### CITATION LIST

### Patent Literature

Patent Literature 1: Japanese Unexamined Patent Application Publication No. 2015-141053

### SUMMARY

However, a voice announcement or a screen message described above can have the following issues.

The driver receiving a voice announcement or a screen message still takes a high degree of concentration on manual driving until the drive mode is completely switched to the automatic drive mode, preparing for handling any potential emergency safely and reliably with manual driving. Many drivers understand this situation and keep a high degree of concentration on manual driving for any emergency after receiving such a voice announcement or screen message until the drive mode is completely switched to the automatic drive mode.

After receiving a voice announcement such as “The drive mode will be switched to automatic driving in xx seconds.” or a screen message such as “In xx seconds,” such drivers who continue manual driving while keeping their concentration would appropriately handle any emergency with manual driving.

However, some drivers may take a low degree of concentration during manual driving. When such drivers receive the above voice announcement or screen message, they may be fully relaxed, being aware that they will be shortly freed from manual driving, or may misunderstand that that the mode is already the automatic drive mode and rely on automatic driving with an even lower degree of concentration on manual driving. Such drivers may fail to appropriately handle an emergency with manual driving, which may arise before the drive mode is completely switched to the automatic drive mode.

One or more aspects are directed to a drive mode switch controller, a drive mode switch control system, and a drive mode switch control method for notifying drivers with a high degree of concentration that the drive mode will be switched from the manual drive mode to the automatic drive mode, and preventing drivers with a low degree of concentration from further lowering their concentration.

In response to the above issue, one or more aspects are directed to the following devices and method.

A drive mode switch controller according to a first aspect is for switching a drive mode of a vehicle from a manual drive mode to an automatic drive mode. The controller includes an obtaining unit that obtains sensing data indicating a state of a driver of the vehicle from a monitoring sensor for monitoring the state of the driver, a determination unit that determines a degree of concentration of the driver on driving based on the sensing data, and a notification controller that controls, when the determination unit determines that the degree of concentration satisfies a predetermined first criterion, a notification unit to notify, before the drive mode is switched, the driver that the drive mode will be switched from the manual drive mode to the automatic drive mode, and controls, when the determination unit determines that the degree of concentration does not satisfy the first criterion, the notification unit not to notify, before the drive mode is switched, the driver that the drive mode will be switched from the manual drive mode to the automatic drive mode.

A drive mode switch controller according to a second aspect is the drive mode switch controller according to a first aspect in which the obtaining unit stores, into a storage, the obtained sensing data in response to a request for switching the drive mode from the manual drive mode to the automatic drive mode, and the determination unit determines the degree of concentration of the driver on driving based on the sensing data stored in the storage.

A drive mode switch controller according to a third aspect is the drive mode switch controller according to a first or second aspect in which the determination unit further determines whether the degree of concentration satisfies a second criterion higher than the first criterion or satisfies the first criterion without satisfying the second criterion, and the notification controller controls the notification unit to notify the driver of the switching through an announcement of voice information and a display of text information when the determination unit determines that the degree of concentration satisfies the second criterion, and controls the notification unit to notify the driver of the switching through the announcement of voice information or the display of text information when the determination unit determines that the degree of concentration satisfies the first criterion without satisfying the second criterion.

A drive mode switch controller according to a fourth aspect is the drive mode switch controller according to any one of first to third aspects in which the sensing data includes an image of the driver captured by a monitoring camera, and the determination unit identifies a movement of the driver from the image and determines the degree of concentration based on an identification result of the movement and a predetermined criterion for the movement of the driver.

A drive mode switch control system according to a fifth aspect is for switching a drive mode of a vehicle from a manual drive mode to an automatic drive mode. The system includes a monitoring sensor for monitoring a state of a driver, an obtaining unit that obtains sensing data indicating the state of the driver from the monitoring sensor, a determination unit that determines a degree of concentration of the driver on driving based on the sensing data, a notification unit that notifies the driver that the drive mode will be switched, and a notification controller that controls, when the determination unit determines that the degree of concentration satisfies a predetermined first criterion, the notification unit to notify, before the drive mode is switched, the driver that the drive mode will be switched from the manual drive mode to the automatic drive mode, and controls, when the determination unit determines that the degree of concentration does not satisfy the first criterion, the notification unit not to notify, before the drive mode is switched, the driver that the drive mode will be switched.

A drive mode switch control system according to a sixth aspect is the drive mode switch control system according to a fifth aspect in which the obtaining unit stores the obtained sensing data into a storage in response to a request for switching the drive mode from the manual drive mode to the automatic drive mode, and the determination unit determines the degree of concentration of the driver on driving based on the sensing data stored in the storage.

A drive mode switch control system according to a seventh aspect is the drive mode switch control system according to a fifth or sixth aspect in which the notification unit includes a speaker that outputs voice information indicating that the drive mode will be switched to the automatic drive mode.

A drive mode switch control system according to an eighth aspect is the drive mode switch control system according to a fifth or sixth aspect in which the notification unit includes a display screen that displays text information indicating that the drive mode will be switched to the automatic drive mode.

A drive mode switch control system according to a ninth aspect is the drive mode switch control system according to a fifth or sixth aspect in which the determination unit further determines whether the degree of concentration satisfies a second criterion higher than the first criterion or satisfies the first criterion without satisfying the second criterion, and the notification controller controls the notification unit to notify the driver of the switching through an announcement of voice information and a display of text information when the determination unit determines that the degree of concentration satisfies the second criterion, and controls the notification unit to notify the driver of the switching through the announcement of the voice information or the display of the text information when the determination unit determines that the degree of concentration satisfies the first criterion without satisfying the second criterion.

A drive mode switch control system according to a tenth aspect is the drive mode switch control system according to any one of fifth to ninth aspects in which the monitoring sensor includes a monitoring camera that captures an image of the driver.

A drive mode switch control system according to an eleventh aspect is the drive mode switch control system according to a fifth or sixth aspect in which the sensing data includes an image of the driver captured by the monitoring camera, and the determination unit identifies a movement of the driver from the image and determines the degree of concentration based on an identification result of the movement and a predetermined criterion for the movement of the driver.

A drive mode switch control method according to a twelfth aspect is for switching a drive mode of a vehicle from a manual drive mode to an automatic drive mode. The method includes obtaining sensing data indicating a state of the driver from a monitoring sensor for monitoring the state of the driver, determining a degree of concentration of the driver on driving based on the sensing data, and controlling, when the degree of concentration is determined to satisfy a predetermined first criterion, the notification unit to notify, before the drive mode is switched, the driver that the drive mode will be switched to the automatic drive mode, and controlling, when the degree of concentration is determined not to satisfy the first criterion, the notification unit not to notify, before the drive mode is switched, the driver that the drive mode will be switched.

The controller according to first, fifth, and twelfth aspects determines the degree of concentration of the driver on driving based on the sensing data.

Particularly, the controller according to second and sixth aspects determines the degree of concentration of the driver on driving based on the sensing data in response to a switching request from the manual drive mode to the automatic drive mode.

The controller according to one or more aspects notifies the driver that the drive mode will be switched from the manual drive mode to the automatic drive mode before the drive mode is switched from the manual drive mode to the automatic drive mode when the degree of concentration is determined to satisfy a predetermined first criterion, and does not notify the driver that the drive mode will be switched when the degree of concentration is determined not to satisfy the predetermined first criterion.

Thus, drivers with a high degree of concentration who satisfy the predetermined first criterion are reliably notified that the drive mode will be switched from the manual drive mode to the automatic drive mode before the drive mode is switched from the manual drive mode to the automatic drive mode.

Drivers with a low degree of concentration who do not satisfy the predetermined first criterion are not notified that the drive mode will be switched from the manual drive mode to the automatic drive mode before the drive mode is switched from the manual drive mode to the automatic drive mode. When drivers with a low degree of concentration receive such information, they may be fully relaxed, being aware that they will be shortly freed from manual driving, or may misunderstand that that the mode is already the automatic drive mode and rely on automatic driving with even a lower degree of concentration. Thus, they may fail to appropriately handle an emergency with manual driving before the drive mode is completely switched to the automatic drive mode. This structure thus intentionally avoids notifying the driver with a low degree of concentration that the drive mode will be switched from the manual drive mode to the automatic drive mode to avoid lowering the concentration of the driver further and producing the adverse effects described above.

This structure can thus safely and reliably switch the drive mode from the manual drive mode to the automatic drive mode for drivers driving with a low degree of concentration.

The controller according to third and ninth aspects can vary the notification for drivers with different degrees of concentration that satisfy a predetermined first criterion.

The controller according to fourth, tenth, and eleventh aspects allows the image of the driver captured by the monitoring camera to be used in determining the degree of concentration. The movement of the driver can thus be identified, allowing the degree of concentration to be determined with high accuracy.

The controller according to a seventh aspect reliably notifies the driver that the drive mode will be switched to the automatic drive mode by outputting voice information from the speaker.

The controller according to an eighth aspect reliably notifies the driver that the drive mode will be switched to the automatic drive mode by outputting text information on the display screen.

The controller, the control system, and the control method according to one or more aspects are applicable to switching of the drive mode from the manual drive mode to the automatic drive mode of any of levels 1 to 4 of automatic driving described above, and particularly to the level-4 automatic drive mode.

### BRIEF DESCRIPTION OF THE DRAWINGS

FIG. 1 is a schematic diagram illustrating an automatic driving control system including a drive mode switch control system according to one or more embodiments.

FIG. 2 is a functional block diagram illustrating a drive mode switch control system according to one or more embodiments.

FIG. 3 is a flow diagram illustrating an operation of a drive mode switch control system according to one or more embodiments.

FIG. 4 is a flow diagram illustrating an operation of a drive mode switch control system according to one or more embodiments.

### DETAILED DESCRIPTION

One or more embodiments will now be described with reference to the drawings.

### Structure

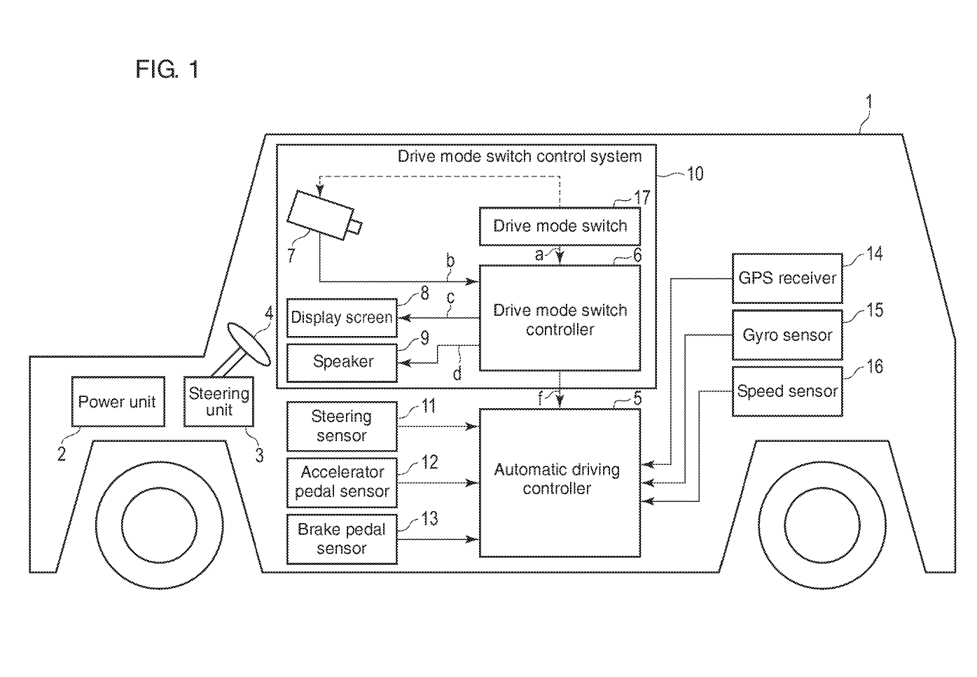

FIG. 1 is a schematic diagram of an automatic driving control system including a drive mode switch control system 10 according to one or more embodiments. The automatic driving control system is mounted on a vehicle 1, such as an automobile.

The vehicle 1 includes, as its basic components, a power unit 2 including a power supply and a transmission, and a steering unit 3 incorporating a steering wheel 4. The vehicle 1 has two drive modes, a manual drive mode and an automatic drive mode. The power supply includes an engine, a motor, or both.

The manual drive mode allows the vehicle 1 to travel mainly based on, for example, a manual driving operation performed by a driver. For example, the manual drive mode includes a vehicle driving operation mode for driving a vehicle with a driving operation performed by a driver alone, and an assisted driving mode for driving a vehicle mainly with a driving operation performed by a driver in combination with assisted driving.

When, for example, the vehicle 1 travels along a curve, assisted driving assists the driver with the steering torque to achieve an appropriate steering quantity based on the curvature of the curve. Assisted driving further includes control for assisting the driver's acceleration (e.g., accelerator pedal operation) or braking (e.g., brake pedal operation), manual steering (manual steering during driving), and manual speed regulation (manual speed control during driving). Manual steering refers to steering the vehicle 1 mainly with the driver's operation on the steering wheel 4. Manual speed regulation refers to adjusting the speed of the vehicle mainly with the driver's accelerating operation or braking operation.

Assisted driving excludes control for forcibly interrupting the driver's driving operation for automatically driving the vehicle 1. In other words, the manual drive mode reflects the driver's operation on the traveling vehicle within a predetermined allowable range, but excludes any control for forcibly interrupting the vehicle traveling under predetermined conditions (e.g., deviation of the vehicle from a lane).

In contrast, the automatic drive mode enables automatic driving of a vehicle 1 along a road on which the vehicle 1 is traveling. The automatic drive mode includes automatic driving of a vehicle 1 to a predetermined destination without the driver performing a driving operation. The automatic drive mode is not limited to complete automatic control of the vehicle 1, and includes driving that reflects the driver's operation in the traveling vehicle 1 within a predetermined allowable range.

In other words, the automatic drive mode includes control for forcibly interrupting the vehicle travelling under predetermined conditions while reflecting the driver's operation on the traveling vehicle 1 within a predetermined allowable range.

FIG. 1 shows an automatic driving controller 5, which controls driving in the automatic drive mode. The automatic driving controller 5 obtains sensing data from a steering sensor 11, an accelerator pedal sensor 12, a brake pedal sensor 13, a global positioning system (GPS) receiver 14, a gyro sensor 15, and a speed sensor 16. The automatic driving controller 5 automatically controls the travelling of the vehicle 1 based on the sensing data, route information generated by a navigation system (not shown), traffic information obtained through road-to-vehicle communication, and information obtained by a surrounding monitoring system that monitors the positions and movements of nearby pedestrians and vehicles.

The automatic control includes autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane when, for example, the driver is not performing a steering operation. During the operation of LKA, the steering operation of the driver may be reflected in the vehicle steering within the range in which the vehicle 1 stays in the driving lane (allowable range). Autosteering is not limited to LKA.

Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle. During the operation of ACC, the automatic driving controller 5 decelerates the vehicle 1 in response to the driver's braking (e.g., brake pedal operation), or may accelerate the vehicle 1 in response to the driver's acceleration (e.g., accelerator pedal operation) up to a predetermined maximum permissible speed (e.g., the legally defined maximum speed on the road being traveled). Automatic speed regulation is not limited to ACC, but may include cruise control (CC) that performs constant speed control alone.

The automatic driving control system according to one or more embodiments includes a drive mode switch control system 10, which controls switching of the drive mode between the manual drive mode and the automatic drive mode.

The drive mode switch control system 10 according to one or more embodiments implements a drive mode switch control method featuring switching from the manual drive mode to the automatic drive mode. The control for switching from the manual drive mode to the automatic drive mode will be described below, whereas switching from the automatic drive mode to the manual drive mode will not be described.

The drive mode switch control system 10 includes a drive mode switch controller 6, a driver camera 7 serving as a monitoring sensor, a display screen 8, a speaker 9, and a drive mode switch 17.

The drive mode switch 17 outputs a signal a for requesting to switch the drive mode (hereafter, switching request signal a) to the drive mode switch controller 6. In response to the driver pressing the drive mode switch 17, the switching request signal a is output to the drive mode switch controller 6. In response to the signal, the drive mode switch controller 6 starts drive mode switching control. The drive mode switch controller 6 can also start the drive mode switching control from the manual drive mode to the automatic drive mode through road-to-vehicle communication or while the vehicle is traveling along a highway.

As described above, the drive mode switch control system 10 according to one or more embodiments features the control for switching the drive mode from the manual drive mode to the automatic drive mode, which will be described below.

The driver camera 7 is installed in front of a driver, such as on the dashboard, to capture images of the driver. The driver camera 7 outputs video signals b representing the captured images to the drive mode switch controller 6. As indicated with a dotted line in the drawing, the driver camera 7 may start capturing images in response to a switching request signal a output from the drive mode switch 17, or may constantly capture images of the driver independently of the signal output.

The display screen 8 displays text information c representing messages output from the drive mode switch controller 6. The display screen 8 may correspond to, for example, a meter of the vehicle 1 or a display screen of a car navigation system mounted on the vehicle 1, but is not limited to these and may for example be a monitor screen of a driving monitor mounted on the vehicle 1.

The speaker 9 outputs voice information d representing messages output from the drive mode switch controller 6.

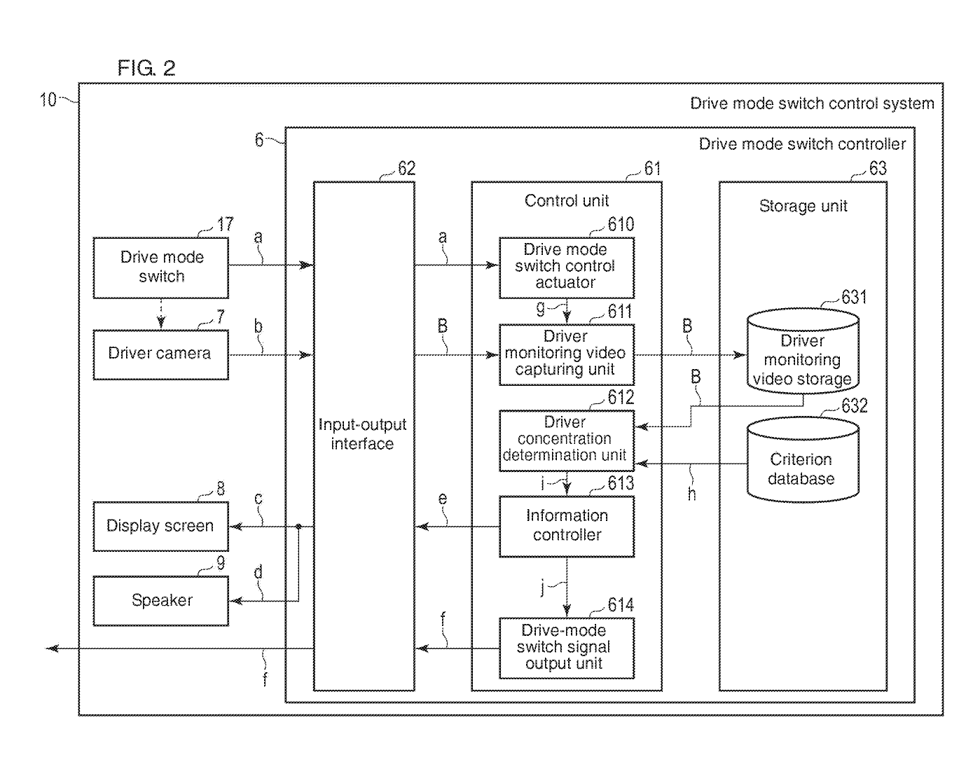

FIG. 2 is a functional block diagram of the drive mode switch control system 10 according to one or more embodiments.

The drive mode switch controller 6 centrally controls the switching between the drive modes, and includes a control unit 61, an input-output interface 62, and a storage unit 63.

The input-output interface 62 receives a switching request signal a output from the drive mode switch 17, and outputs the signal to the control unit 61. The input-output interface 62 receives video signals b output from the driver camera 7, and converts the signals b into digital data B. The input-output interface 62 then outputs the digital data B to the control unit 61. The input-output interface 62 also converts message information e output from the control unit 61 into text information c and voice information d, and outputs the text information c to the display screen 8, and the voice information d to the speaker 9. The input-output interface 62 also outputs drive mode switching control signals f output from the control unit 61 to the automatic driving controller 5.

The storage unit 63 includes, as a storage medium, a nonvolatile memory, such as a solid state drive (SSD) or a hard disk drive (HDD), which is writable and readable as appropriate. The storage unit 63 includes, as a storage area used for implementing one or more embodiments, a driver monitoring video storage 631 and a criterion database 632.

The control unit 61 includes a central processing unit (CPU) included in a computer and a program memory. The control unit 61 includes, as its control functions for implementing one or more embodiments, a drive mode switch control actuator 610, a driver monitoring video capturing unit 611, a driver concentration determination unit 612, a notification controller 613, and a drive-mode switch signal output unit 614. These control functions are implemented by the CPU executing programs stored in the program memory.

The drive mode switch control actuator 610 receives switching request signals a output through the input-output interface 62, and then outputs starting signals g to the driver monitoring video capturing unit 611 to actuate the driver monitoring video capturing unit 611. Thus, the drive mode switch controller 6 starts the control procedure for switching from the manual drive mode to the automatic drive mode.

In response to the starting signals g from the drive mode switch control actuator 610, the driver monitoring video capturing unit 611 receives, through the input-output interface 62, digital data B (driver monitoring video data B) for the driver video signals output from the driver camera 7, and stores the received driver monitoring video data B into the driver monitoring video storage 631 in the storage unit 63. Thus, the driver monitoring video storage 631 stores the driver monitoring video data B indicating the state of the driver.

Irrespective of whether the starting signals g are output from the drive mode switch control actuator 610, the driver monitoring video capturing unit 611 may constantly receive the digital data B (driver monitoring video data B) for driver video signals output from the driver camera 7 through the input-output interface 62, and store the driver monitoring video data B into the driver monitoring video storage 631 in the storage unit 63.

The driver concentration determination unit 612 identifies the movement of the driver based on the driver monitoring video data B stored in the driver monitoring video storage 631. The driver concentration determination unit 612 determines the degree of concentration of the driver on driving based on the identification result and a predetermined criterion h for the movement of the driver stored in the criterion database 632, and outputs a determination result i to the notification controller 613.

The degree of concentration is an index of how suitable the driver is for driving. When, for example, the driver is in the normal state of driving the vehicle 1, most of the movements of the driver are gazing forward and looking in a rear-view mirror or side mirrors. The driver in this state is regarded as being fully concentrated on driving. In contrast, the driver is regarded as failing to concentrate on driving when, for example, the driving driver fails to gaze forward, talks, is drowsy, is bringing foods into his/her mouth, or is operating or talking on a mobile phone or smartphone (although the driver is not allowed to) (refer to, for example, Patent Literature 1).

Thus, the driver concentration determination unit 612 determines that the driver has a high degree of concentration when satisfying a criterion that gazing forward or looking in the mirrors reaches or exceeds, for example, 80% of the movements of the driver identified based on the driver monitoring video data B stored in the driver monitoring video storage 631. In contrast, the driver concentration determination unit 612 determines that the driver has a low degree of concentration when, for example, the degree of gazing forward or looking in the mirrors is equal to or below 20% of the movements of the driver identified based on the driver monitoring video data B, or when the movements of the driver include operating or talking on a mobile phone or smartphone.

The above criterion h is a mere example, and may be appropriately set by a designer and stored in the criterion database 632 for use in the determination performed by the driver concentration determination unit 612. To change the criterion h, the criterion h stored in the criterion database 632 may be changed.

Other examples of the criterion h include the degree of concentration quantified based on time-series movements of the driver by multiplying a predetermined score set for each typical movement by the ratio of the time of the movement with respect to the entire time length and summing up the resultants. For example, each movement may have a predetermined score, such as 1 for gazing forward, 0.5 for looking in the mirrors, 0.2 for being drowsy, or 0.1 for operating or talking on a mobile phone or smartphone. When the period of 60 seconds consists of gazing forward for 10 seconds, looking in the mirrors for 10 seconds, being drowsy for 10 seconds, and operating a smartphone for 30 seconds, the degree of concentration is calculated as 33% from the following formula, in which a movement with a smaller score is used for the movement performed at the same time:

(1×10+0.5×10+0.2×10+0.1×30)/60=0.333.

For example, the driver may be determined to have a low degree of concentration when the degree of concentration is lower than 40%, and the driver may be determined not to have a low degree of concentration when the degree of concentration is higher than or equal to 40%.

The degree of concentration is not limited to being classified into one of two degrees. For example, the degree of concentration may be classified into one of three degrees by additionally setting an intermediate degree of concentration between a high degree of concentration and a low degree of concentration, or one of four or more levels. As described above, quantifying the degree of concentration is appropriate for classifying the degree of concentration into one of a large number of degrees.

The notification controller 613 receives the determination result i from the driver concentration determination unit 612. When the determination result i indicates that the degree of concentration is not low, the notification controller 613 generates message information e indicating that the drive mode will be switched from the manual drive mode to the automatic drive mode, and outputs the message information e to the input-output interface 62. As described above, the input-output interface 62 converts the message information e into text information c and voice information d, and outputs the text information c to the display screen 8, and the voice information d to the speaker 9. Thus, a voice announcement such as “The drive mode will be switched to automatic driving in xx seconds.” is output from the speaker 9, and minimum text information for notifying switching to the automatic drive mode, such as “In xx seconds,” appears on the display screen 8 in a scale that does not interrupt manual driving.

When the notification controller 613 receives, from the driver concentration determination unit 612, the determination result i indicating that the degree of concentration is low, the notification controller 613 does not output the message information e to the input-output interface 62. Thus, neither the voice information d notifying switching from the manual drive mode to the automatic drive mode is output from the speaker 9 nor the text information c notifying the switching appears on the display screen 8.

As described above, the degree of concentration may be classified into one of three or more degrees. When, for example, the degree of concentration is classified into one of three degrees, the degrees other than a low degree of concentration include high and intermediate degrees of concentration. In this case, the input-output interface 62 may output the text information c to the display screen 8 and the voice information d to the speaker 9 for the driver with a high degree of concentration, and may output either the text information c to the display screen 8 or the voice information d to the speaker 9 for the driver with an intermediate degree of concentration. Thus, the notification may be varied for drivers with different degrees of concentration excluding the low degree of concentration.

The notification controller 613 then outputs an operation signal j to the drive-mode switch signal output unit 614. In response to the signal, the drive-mode switch signal output unit 614 outputs a drive mode switching control signal f for switching the drive mode from the manual drive mode to the automatic drive mode to the input-output interface 62. As described above, the input-output interface 62 outputs the drive mode switching control signal f to the automatic driving controller 5.

In response to the drive mode switching control signal f, the automatic driving controller 5 switches the drive mode from the manual drive mode to the automatic drive mode.

When the driver concentration determination unit 612 determines that the degree of concentration of the driver is other than the low degree of concentration, either one or both of the display screen 8 and the speaker 9 notify the driver that the drive mode will be switched from the manual drive mode to the automatic drive mode before the drive mode is switched. When the driver concentration determination unit 612 determines that the driver has a low degree of concentration, the drive mode is switched from the manual drive mode to the automatic drive mode without notifying the driver of the switching.

### Operation

The operation of the drive mode switch control system 10 with the above structure according to one or more embodiments will now be described.

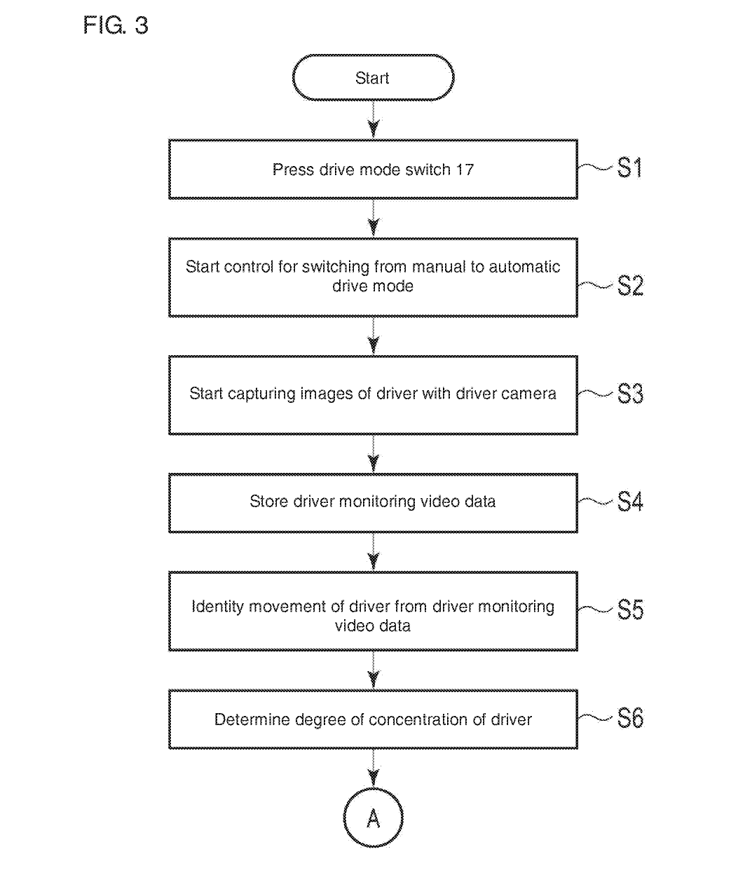

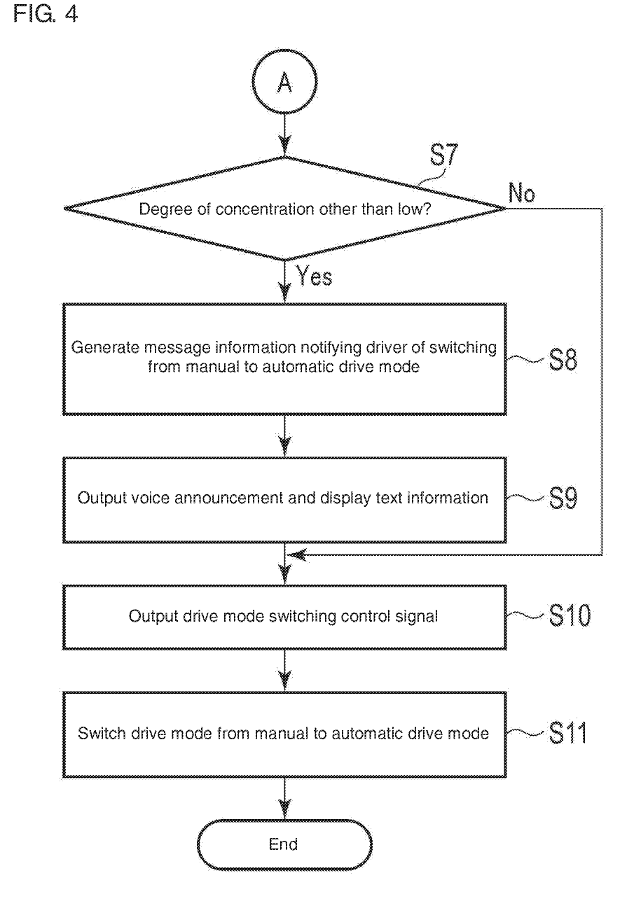

FIGS. 3 and 4 are flowcharts showing the operation of the drive mode switch control system 10 according to one or more embodiments.

The driver presses the drive mode switch 17 to switch the drive mode from the manual drive mode to the automatic drive mode. In response to this operation, a switching request signal is transmitted from the drive mode switch 17 to the drive mode switch controller 6. The switching request signal a transmitted to the drive mode switch controller 6 is output to the drive mode switch control actuator 610 through the input-output interface 62 (S1).

In response to the switching request signal a, the drive mode switch control actuator 610 outputs a starting signal g to the driver monitoring video capturing unit 611. In response to the signal, the driver monitoring video capturing unit 611 is actuated to start the entire control procedure for switching from the manual drive mode to the automatic drive mode (S2). The drive mode switch controller 6 may also start the drive mode switching control from the manual drive mode to the automatic drive mode through road-to-vehicle communication or during traveling along an expressway.

In response to the switching request signal a output from the drive mode switch 17, the driver camera 7 starts capturing images of the driver, and outputs the video signals b representing the captured images to the drive mode switch controller 6 (S3). The driver camera 7 may constantly capture images of the driver irrespective of whether the switching request signals a are output, and may output the video signals b representing the captured images to the drive mode switch controller 6.

The driver video signals b output from the driver camera 7 are converted into digital data (driver monitoring video data) B by the input-output interface 62, and the driver monitoring video data B is output through the input-output interface 62 to the driver monitoring video capturing unit 611. The driver monitoring video data B is then output from the driver monitoring video capturing unit 611 to the driver monitoring video storage 631, and stored in the driver monitoring video storage 631 (S4). Thus, the driver monitoring video storage 631 stores the driver monitoring video data B representing the driver's state.

The driver monitoring video data B stored in the driver monitoring video storage 631 is used by the driver concentration determination unit 612 for determining the degree of concentration. More specifically, the driver monitoring video capturing unit 611 first identifies the movement of the driver based on the driver monitoring video data B stored in the driver monitoring video storage 631 (S5).

Subsequently, the degree of concentration of the driver on driving is determined based on the identification result obtained in step S5 and the criterion h stored in advance in the criterion database 632, and the determination result i is output to the notification controller 613 (S6).

When the determination result i indicates that the degree of concentration of the driver is other than the low degree of concentration (Yes in S7), the notification controller 613 generates the message information e indicating that the drive mode will be switched from the manual drive mode to the automatic drive mode, and outputs the message information e to the input-output interface 62 (S8).

The input-output interface 62 converts the message information e into the text information c and the voice information d, and outputs the text information c to the display screen 8, and the voice information d to the speaker 9. Thus, a voice announcement such as “The drive mode will be switched to automatic driving in xx seconds.” is output from the speaker 9, and minimum text information for notifying switching to the automatic drive mode, such as “In xx seconds,” appears on the display screen 8 (S9) in a scale that does not interrupt manual driving.

When the determination result i indicates that the driver has a low degree of concentration (No in S7), the notification controller 613 does not output the message information e to the input-output interface 62. Thus, neither the voice information d notifying switching from the manual drive mode to the automatic drive mode is output from the speaker 9 nor the text information c notifying the switching appears on the display screen 8.

The operation signal j is then output from the notification controller 613 to the drive-mode switch signal output unit 614. In response to the signal, the drive mode switching control signal f for switching the drive mode from the manual drive mode to the automatic drive mode is output from the drive-mode switch signal output unit 614 to the input-output interface 62 (S10).

The drive mode switching control signal f is then output through the input-output interface 62 to the automatic driving controller 5. In response to the signal, the automatic driving controller 5 is actuated to switch the drive mode from the manual drive mode to the automatic drive mode (S11).

### Effects

As described above, the drive mode switch control system 10 according to one or more embodiments can determine the degree of concentration of the driver based on the driver monitoring video data B and the criterion h in response to a switching request from the manual drive mode to the automatic drive mode.

When the degree of concentration of the driver is determined to be other than the low degree of concentration, either one or both of the display screen 8 and the speaker 9 notify the driver that the drive mode will be switched from the manual drive mode to the automatic drive mode before the drive mode is switched from the manual drive mode to the automatic drive mode. When the degree of concentration of the driver is determined to be low, the drive mode is switched from the manual drive mode to the automatic drive mode without notifying the driver of the switching.

This structure reliably notifies the driver with a high degree of concentration that the drive mode will be switched from the manual drive mode to the automatic drive mode before the drive mode is switched.

This structure switches the drive mode from the manual drive mode to the automatic drive mode without notifying the driver with a low degree of concentration of such switching. When drivers with a low degree of concentration receive the text information c or the voice information d, they may be fully relaxed, being aware that they will be shortly freed from manual driving, or may misunderstand that that the mode is already the automatic drive mode and rely on automatic driving with even a lower degree of concentration. Thus, they may fail to appropriately handle an emergency with manual driving before the drive mode is completely switched to the automatic drive mode. This structure thus intentionally avoids notifying the driver with a low degree of concentration that the drive mode will be switched from the manual drive mode to the automatic drive mode to avoid lowering the concentration of the driver further and producing the adverse effects described above.

This structure can thus safely and reliably switch the drive mode from the manual drive mode to the automatic drive mode for drivers driving with a low degree of concentration.

The degree of concentration is not limited to being classified into one of two degrees, or high and low degrees of concentration, and may be appropriately classified into one of three degrees, or high, intermediate, and low degrees of concentration, or four or more degrees. To classify the degree of concentration into, for example, one of three degrees, the degrees other than the low degree of concentration include high and intermediate degrees of concentration. In this case, the display screen 8 may output the text information c and the speaker 9 may output the voice information d for a driver with a high degree of concentration, whereas either the display screen 8 may output the text information c or the speaker 9 may output the voice information d for a driver with an intermediate degree of concentration. Thus, the notification may be varied for drivers with different degrees of concentration excluding the low degree of concentration.

The criterion h used for determining the degree of concentration is stored in the criterion database 632. The degree of concentration can be easily determined by appropriately changing the criterion h stored in the criterion database 632.

Although embodiments have been described with reference to the appended drawings, the present invention is not limited to the above embodiments. Variations and modifications may occur to those skilled in the art within the spirit and scope of the present invention defined by the claims. Such variations and modifications can fall within the technical scope of the present invention.

### Modifications

In one or more embodiments, for example, the degree of concentration of the driver is determined based on the driver monitoring video data B. The driver monitoring video data B is effective data for determining the degree of concentration of the driver. To further improve the determination accuracy, other types of sensing data such as vital signs including the heartbeat of the driver or the movement data of the steering wheel 4 may be appropriately used to determine the degree of concentration in addition to the driver monitoring video data B.

To reflect the vital signs of the driver, a sensor (not shown) such as a heartbeat sensor for detecting the vital signs of the driver may be provided to output the detection results to the driver concentration determination unit 612. To reflect the movement data of the steering wheel 4, the detection results are output to the driver concentration determination unit 612.

The criterion database 632 also stores criteria for reflecting the detection results from the sensor or a steering sensor 11 in determining the degree of concentration.

Thus, the driver concentration determination unit 612 can determine the degree of concentration of the driver based on the sensing data detected by the sensor or the steering sensor 11, in addition to the driver monitoring video data B.

Thus, the drive mode switch control system according to the present modification can determine the degree of concentration of the driver based on any appropriate sensing data in addition to the driver monitoring video data B with higher accuracy.

One or more embodiments may be partially or entirely expressed in, but not limited to, the following forms shown in the appendixes below.

### APPENDIX 1

A drive mode switch controller for switching a drive mode of a vehicle from a manual mode to an automatic drive mode, the controller comprising a hardware processor configured to

obtain sensing data indicating a state of a driver from a monitoring sensor for monitoring the state of the driver,

determine a degree of concentration of the driver on driving based on the sensing data,

control, when the determination determines that the degree of concentration satisfies a predetermined first criterion, a notification unit to notify, before the drive mode is switched, the driver that the drive mode will be switched from the manual drive mode to the automatic drive mode, and controls, when the determination determines that the degree of concentration does not satisfy the first criterion, the notification unit not to notify, before the drive mode is switched, the driver that the drive mode will be switched from the manual drive mode to the automatic drive mode.

### APPENDIX 2

A drive mode switch control system for switching a drive mode of a vehicle from a manual drive mode to an automatic drive mode, the system comprising a monitoring sensor for monitoring a state of a driver, a notification unit configured to notify the driver that the drive mode will be switched, and a hardware processor, the hardware processor being configured to

obtain sensing data indicating the state of the driver from the monitoring sensor,

determine a degree of concentration of the driver on driving based on the sensing data, and

control, when the determination determines that the degree of concentration satisfies a predetermined first criterion, the notification unit to notify, before the drive mode is switched, the driver that the drive mode will be switched from the manual drive mode to the automatic drive mode, and control, when the determination determines that the degree of concentration does not satisfy the first criterion, the notification unit not to notify, before the drive mode is switched, the driver that the drive mode will be switched.

### APPENDIX 3

A drive mode switch control method for switching a drive mode of a vehicle from a manual drive mode to an automatic drive mode, the method comprising:

obtaining, with at least one hardware processor, sensing data indicating a state of a driver of the vehicle from a monitoring sensor for monitoring the state of the driver;

determining, with the at least one hardware processor, a degree of concentration of the driver on driving based on the sensing data; and

controlling, with the at least one hardware processor, a notification unit to notify the driver that the drive mode will be switched to the automatic drive mode before the drive mode is switched when the degree of concentration is determined to satisfy a predetermined first criterion, and controlling the notification unit not to notify the driver that the drive mode will be switched before the drive mode is switched when the degree of concentration is determined not to satisfy the first criterion.

1. A drive mode switch controller for switching a drive mode of a vehicle from a manual drive mode to an automatic drive mode, the controller comprising a processor configured with a program to perform operations comprising:
operation as an obtaining unit configured to obtain sensing data indicating a state of a driver of the vehicle from a monitoring sensor for monitoring the state of the driver;
operation as a determination unit configured to determine a degree of concentration of the driver on driving based on the sensing data; and
operation as a notification controller configured to control, in response to a determination by the determination unit that the degree of concentration satisfies a predetermined first criterion, a notification unit to notify, before the drive mode is switched, the driver that the drive mode will be switched from the manual drive mode to the automatic drive mode, and control, in response to a determination by the determination unit that the degree of concentration does not satisfy the first criterion, the notification unit not to notify, before the drive mode is switched, the driver that the drive mode will be switched from the manual drive mode to the automatic drive mode.

2. The drive mode switch controller according to claim 1, wherein the processor is configured with the program to perform operations such that:
operation as the obtaining unit is further configured to store, into a storage, the obtained sensing data in response to a request for switching the drive mode from the manual drive mode to the automatic drive mode; and
operation as the determination unit is further configured to determine the degree of concentration of the driver on driving based on the sensing data stored in the storage.

3. The drive mode switch controller according to claim 1, wherein the processor is configured with the program to perform operations such that:
operation as the determination unit is further configured to determine whether the degree of concentration satisfies a second criterion higher than the first criterion or satisfies the first criterion without satisfying the second criterion; and
operation as the notification controller is further configured to control the notification unit to notify the driver of the switching through an announcement of voice information and a display of text information in response to a determination by the determination unit that the degree of concentration satisfies the second criterion, and controls the notification unit to notify the driver of the switching through the announcement of voice information or the display of text information in response to a determination by the determination unit that the degree of concentration satisfies the first criterion without satisfying the second criterion.

4. The drive mode switch controller according to claim 1, wherein
the sensing data comprises an image of the driver captured by a monitoring camera, and
the processor is configured with the program to perform operations such that operation as the determination unit is further configured to identify a movement of the driver from the image and determines the degree of concentration based on an identification result of the movement and a predetermined criterion for the movement of the driver.

5. The drive mode switch controller according to claim 2, wherein the processor is configured with the program to perform operations such that:
operation as the determination unit is further configured to determine whether the degree of concentration satisfies a second criterion higher than the first criterion or satisfies the first criterion without satisfying the second criterion; and
operation as the notification controller is further configured to control the notification unit to notify the driver of the switching through an announcement of voice information and a display of text information in response to a determination by the determination unit that the degree of concentration satisfies the second criterion, and controls the notification unit to notify the driver of the switching through the announcement of voice information or the display of text information in response to a determination by the determination unit that the degree of concentration satisfies the first criterion without satisfying the second criterion.

6. The drive mode switch controller according to claim 2, wherein
the sensing data comprises an image of the driver captured by a monitoring camera, and
the processor is configured with the program to perform operations such that operation as the determination unit is further configured to identify a movement of the driver from the image and determines the degree of concentration based on an identification result of the movement and a predetermined criterion for the movement of the driver.

7. A drive mode switch control system for switching a drive mode of a vehicle from a manual drive mode to an automatic drive mode, the system comprising:
a monitoring sensor for monitoring a state of a driver; and
a processor configured with a program to perform operations comprising:
operation as an obtaining unit configured to obtain sensing data indicating the state of the driver from the monitoring sensor;
operation as a determination unit configured to determine a degree of concentration of the driver on driving based on the sensing data;
operation as a notification unit configured to notify the driver that the drive mode will be switched; and
operation as a notification controller configured to control, in response to a determination by the determination unit that the degree of concentration satisfies a predetermined first criterion, the notification unit to notify, before the drive mode is switched, the driver that the drive mode will be switched from the manual drive mode to the automatic drive mode, and control, in response to a determination by the determination unit that the degree of concentration does not satisfy the first criterion, the notification unit not to notify, before the drive mode is switched, the driver that the drive mode will be switched.

8. The drive mode switch control system according to claim 7, wherein the processor is configured with the program to perform operations such that:
operation as the obtaining unit is further configured to store the obtained sensing data into a storage in response to a request for switching the drive mode from the manual drive mode to the automatic drive mode, and
operation as the determination unit is further configured to determine the degree of concentration of the driver on driving based on the sensing data stored in the storage.

9. The drive mode switch control system according to claim 7, wherein
the processor is configured with the program to perform operations such that operation as the notification unit is further configured to cause a speaker to output voice information indicating that the drive mode will be switched to the automatic drive mode.

10. The drive mode switch control system according to claim 7, wherein
the processor is configured with the program to perform operations such that operation as the notification unit is further configured to cause a display screen configured to display text information indicating that the drive mode will be switched to the automatic drive mode.

11. The drive mode switch control system according to claim 7, wherein the processor is configured with the program to perform operations such that:
operation as the determination unit is further configured to determine whether the degree of concentration satisfies a second criterion higher than the first criterion or satisfies the first criterion without satisfying the second criterion, and
operation as the notification controller is further configured to control the notification unit to notify the driver of the switching through an announcement of voice information and a display of text information in response to a determination by the determination unit that the degree of concentration satisfies the second criterion, and controls the notification unit to notify the driver of the switching through the announcement of the voice information or the display of the text information in response to a determination by the determination unit that the degree of concentration satisfies the first criterion without satisfying the second criterion.

12. The drive mode switch control system according to claim 7, wherein
the monitoring sensor comprises a monitoring camera configured to capture an image of the driver.

13. The drive mode switch control system according to claim 7, wherein
the sensing data comprises an image of the driver captured by a monitoring camera, and
the processor is configured with the program to perform operations such that operation as the determination unit is further configured to identify a movement of the driver from the image and determines the degree of concentration based on an identification result of the movement and a predetermined criterion for the movement of the driver.

14. The drive mode switch control system according to claim 8, wherein
the processor is configured with the program to perform operations such that operation as the notification unit is further configured to cause a speaker to output voice information indicating that the drive mode will be switched to the automatic drive mode.

15. The drive mode switch control system according to claim 8, wherein
the processor is configured with the program to perform operations such that operation as the notification unit is further configured to cause a display screen configured to display text information indicating that the drive mode will be switched to the automatic drive mode.

16. The drive mode switch control system according to claim 8, wherein the processor is configured with the program to perform operations such that:
operation as the determination unit is further configured to determine whether the degree of concentration satisfies a second criterion higher than the first criterion or satisfies the first criterion without satisfying the second criterion, and
operation as the notification controller is further configured to control the notification unit to notify the driver of the switching through an announcement of voice information and a display of text information in response to a determination by the determination unit that the degree of concentration satisfies the second criterion, and controls the notification unit to notify the driver of the switching through the announcement of the voice information or the display of the text information in response to a determination by the determination unit that the degree of concentration satisfies the first criterion without satisfying the second criterion.

17. The drive mode switch control system according to claim 8, wherein
the monitoring sensor comprises a monitoring camera configured to capture an image of the driver.

18. The drive mode switch control system according to claim 8, wherein
the sensing data comprises an image of the driver captured by a monitoring camera, and
the processor is configured with the program to perform operations such that operation as the determination unit is further configured to identify a movement of the driver from the image and determines the degree of concentration based on an identification result of the movement and a predetermined criterion for the movement of the driver.

19. A drive mode switch control method for switching a drive mode of a vehicle from a manual drive mode to an automatic drive mode, the method comprising:
obtaining sensing data indicating a state of a driver of the vehicle from a monitoring sensor for monitoring the state of the driver;
determining a degree of concentration of the driver on driving based on the sensing data; and
controlling, in response to determining that the degree of concentration satisfies a predetermined first criterion, a notification unit to notify, before the drive mode is switched, the driver that the drive mode will be switched to the automatic drive mode, and controlling, in response to determining that the degree of concentration does not satisfy the first criterion, the notification unit not to notify, before the drive mode is switched, the driver that the drive mode will be switched.
